(19) United States
(12) Patent Application Publication
(10) Pub. No.: US 2014/0028295 A1
(43) Pub. Date: Jan. 30, 2014

(54) MAGNETIC SENSOR FOR PRESSURE CYLINDER

(71) Applicant: KITA SENSOR TECH. CO., LTD., New Taipei City (TW)

(72) Inventor: David CHEN, Taipei City (TW)

(73) Assignee: KITA SENSOR TECH. CO., LTD., New Taipei City (TW)

(21) Appl. No.: 13/691,449

(22) Filed: Nov. 30, 2012

(30) Foreign Application Priority Data
Jul. 27, 2012 (TW) 101214626

(51) Int. Cl. G01B 7/14

(52) U.S. Cl. CPC G01B 7/14
USPC 324/207.22

(57) ABSTRACT

A magnetic sensor includes a casing body having opposite first and second ends, a receiving notch proximate to the second end, and a through hole communicating with the receiving notch. A positioning unit includes a bushing disposed in the receiving notch and having a protrusion, and an adjustment member having a rotary portion retained rotatably in the through hole, and a head portion fixed to the tubular portion. The bushing is rotatable relative to the casing body between protruded and retracted positions, where the protrusion is protruded out of and retracted into the receiving notch so that the bushing interlocks and uninterlocks with blocking portions of a pressure cylinder, respectively. A sensing module is disposed in the casing body in proximity to the first end.

### CROSS-REFERENCE TO RELATED APPLICATION

This application claims priority of Taiwanese Patent Application No. 101214626, filed on Jul. 27, 2012.

### BACKGROUND OF THE INVENTION

1. Field of the Invention

This invention relates to a magnetic sensor, and more particularly to a magnetic sensor that can be stably disposed in a channel of an outer surface of a pressure cylinder.

2. Description of the Related Art

Referring to FIG. 1, a conventional magnetic sensor 11 is disposed in a channel 121 of an outer surface of a pressure cylinder 12. The channel 121 extends along a length of the pressure cylinder 12. The pressure cylinder 12 may be a pneumatic or a hydraulic cylinder. The pressure cylinder 12 includes a piston 122 disposed reciprocally and linearly within an inner chamber thereof, and a magnetic portion 123 provided on an outer peripheral surface of the piston 122. The piston 122 is movable between a top dead point position and a bottom dead point position. The magnetic portion 123 is movable along with the piston 122. When the magnetic sensor 11 senses magnetism of the magnetic portion 123, it generates and outputs a control signal. Hence, the magnetic sensor 11 can be used to detect a specific location of the piston 122 in the inner chamber of the cylinder.

However, to fix the conventional magnetic sensor 11 in the channel 121, the magnetic sensor 11 is inserted into the channel 121 from a top end to a bottom end thereof, after which a screw bolt 111 is used to fasten a casing 112 of the magnetic sensor 11 to the bottom end of the channel 121. Further, because magnetic electronic components (not shown) in the casing 112 of the magnetic sensor 11 are located distal from the screw bolt 111, when the piston 122 moves from the top dead point position toward the bottom dead point position, the magnetic electronic components can sense in advance the magnetism of the magnetic portion 123, and the magnetic sensor 11, in turn, generates and outputs a sensor signal in response to the sensed magnetism by the magnetic electronic components prior to arrival of the piston 122 to the bottom dead point position. Hence, the position of the piston 122 detected by the conventional magnetic sensor 11 is different from the actual position of the piston 122.

### SUMMARY OF THE INVENTION

Therefore, an object of the present invention is to provide a magnetic sensor that can be easily installed and that has enhanced detection sensitivity.

According to this invention, a magnetic sensor is used for placement in a channel of a pressure cylinder. The channel is formed in an outer surface of the pressure cylinder and extends along a length of the pressure cylinder. The channel is defined by an inner wall, two sidewalls extending outwardly and respectively from two opposite sides of the inner wall, and two spaced-apart blocking portions respectively projecting from outer ends of the sidewalls that are distal from the inner wall toward each other. The pressure cylinder includes an inner chamber that extends along the length thereof, a piston that moves reciprocally and linearly within the inner chamber, and a magnetic portion provided on an outer peripheral surface of the piston. The magnetic sensor comprises a hollow casing, a positioning unit and a circuit unit. The hollow casing includes a casing body that has a width slightly smaller than a distance between the two blocking portions. The casing body has a first end and a second end opposite to each other along a length of the casing body, a receiving notch formed in an outer surface of the casing body in proximity to the second end, and a through hole formed below and communicating with the receiving notch. The positioning unit includes an adjustment member and a bushing. The bushing is disposed in the receiving notch and has a tubular portion, and a protrusion protruding outwardly and radially from an outer peripheral surface of the tubular portion. The adjustment member extends through the tubular portion and has a rotary portion retained rotatably in the through hole, and a head portion fixed to the tubular portion. The bushing is rotatable relative to the casing body between a protruded position and a retracted position. In the protruded position, the protrusion is protruded out of the receiving notch so that the bushing interlocks with the blocking portions of the pressure cylinder. In the retracted position, the protrusion is retracted into the receiving notch so that the bushing uninterlocks with the blocking portions. The circuit unit includes a sensing module disposed in the hollow casing and proximate to the first end. The sensing module has a sensing circuit that is adapted to sense a magnetic field generated by the magnetic portion and that generates and outputs a control signal in response to the sensed magnetic field.

### BRIEF DESCRIPTION OF THE DRAWINGS

Other features and advantages of the present invention will become apparent in the following detailed description of the preferred embodiment of the invention, with reference to the accompanying drawings, in which:

FIG. 1 is a sectional view of a conventional magnetic sensor disposed in a channel of an outer surface of a pressure cylinder;

FIG. 2 is an exploded perspective view of a magnetic sensor according to the preferred embodiment of this invention;

FIG. 3 is a perspective view, illustrating how the magnetic sensor of this invention can be disposed in a channel of a pressure cylinder;

FIG. 4 is a sectional view, illustrating how the magnetic sensor of this invention can detect a piston in a top dead point position;

FIG. 5 is a sectional view, illustrating how the magnetic sensor of this invention can detect the piston in a bottom dead point position;

FIG. 6 is a block diagram of a sensing module;

FIG. 7 is an enlarged fragmentary schematic view of the preferred embodiment in an assembled state, illustrating a bushing in a retracted position;

FIG. 8 is a schematic view, illustrating a width of a hollow casing of the magnetic sensor of this invention being smaller than a distance between two blocking portions of the channel;

FIG. 9 is an enlarged fragmentary schematic view of the preferred embodiment, illustrating the magnetic sensor of this invention being inserted into the channel through a space defined by the two block portions;

FIG. 10 is a view similar to FIG. 9, but illustrating the bushing in a protruded position relative to the hollow casing; and

FIG. 11 is a sectional view taken along line XI-XI of FIG. 10.

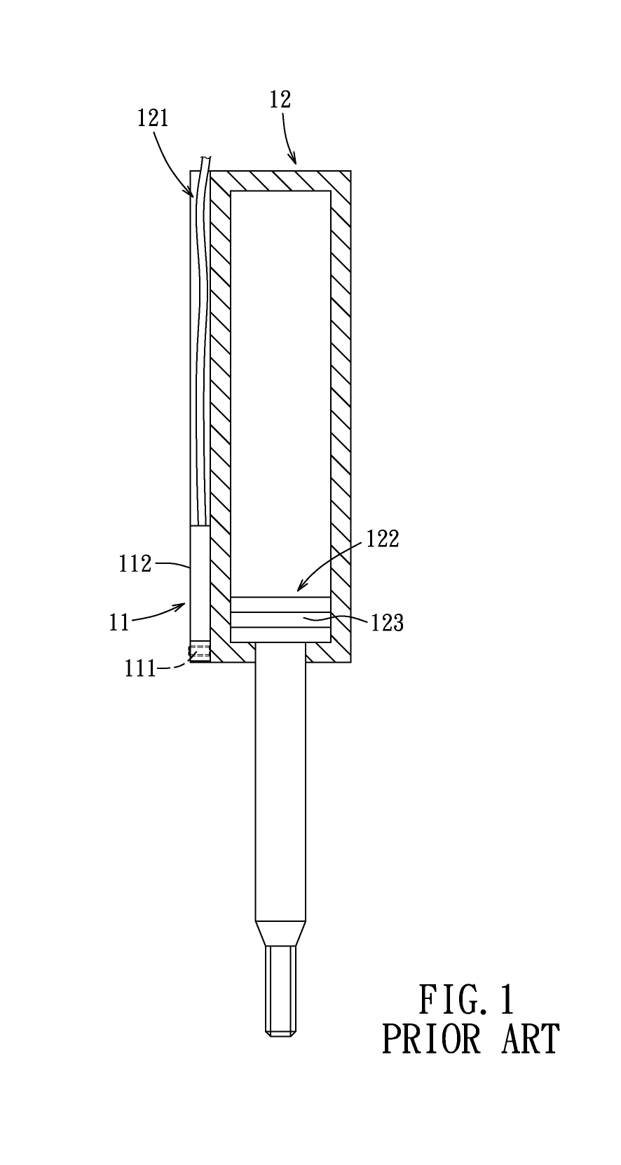

### DETAILED DESCRIPTION OF THE PREFERRED EMBODIMENT

The above-mentioned and other technical contents, features, and effects of this invention will be clearly presented from the following detailed description of one preferred embodiment in coordination with the reference drawings.

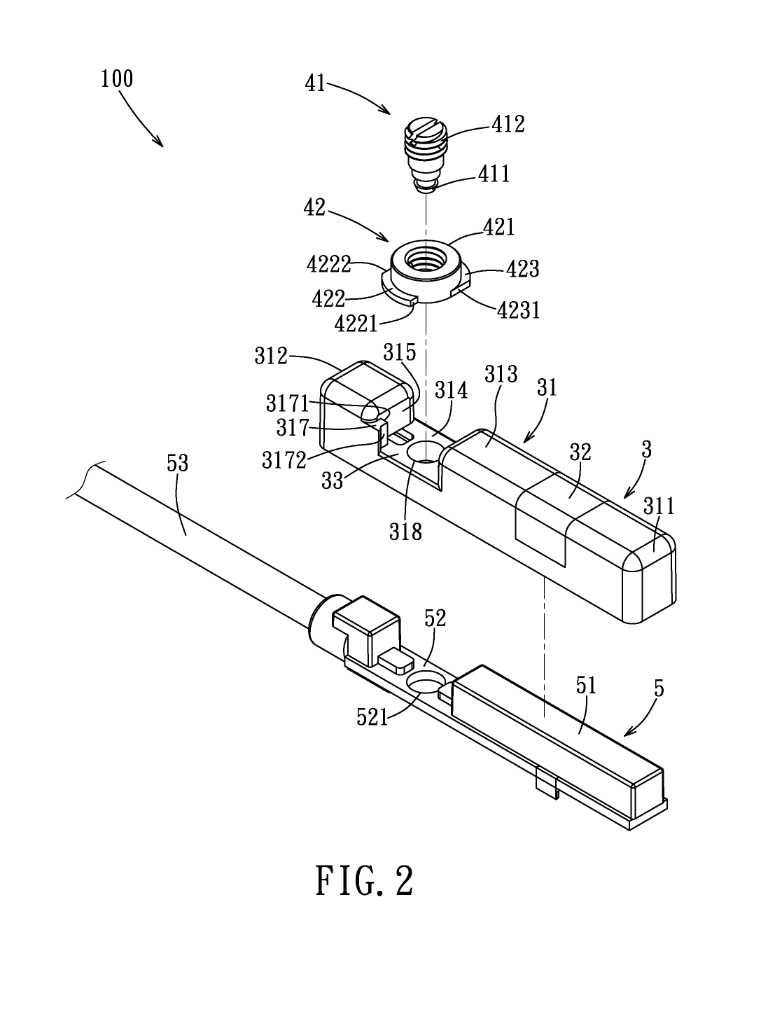

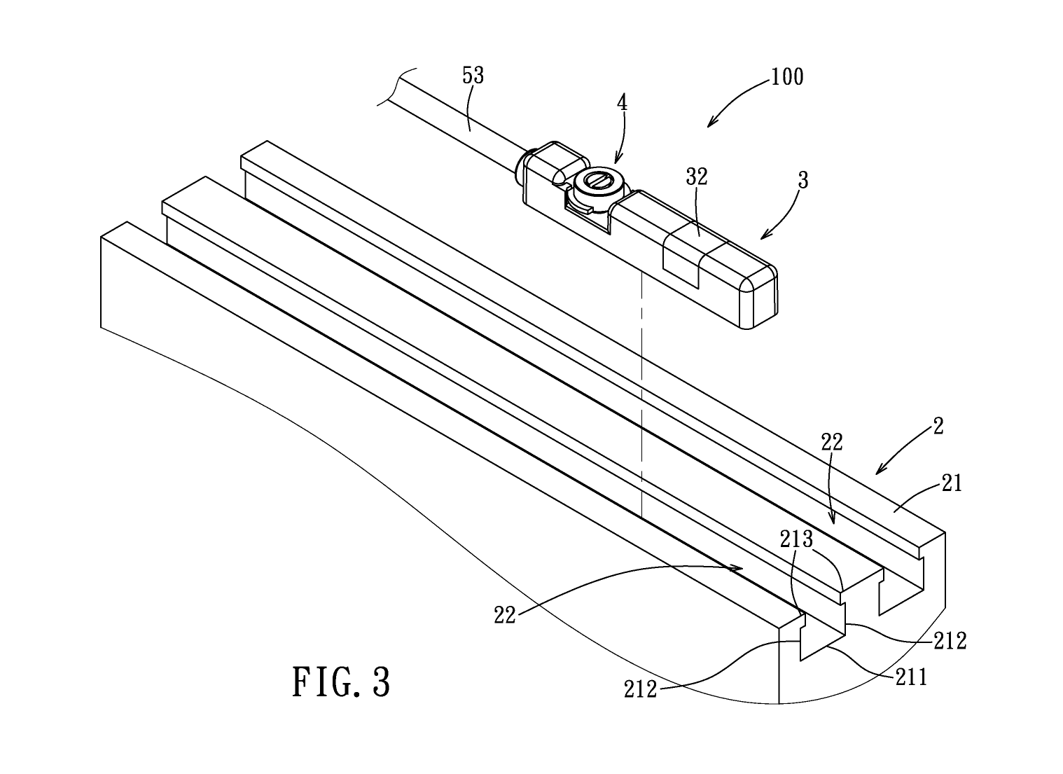

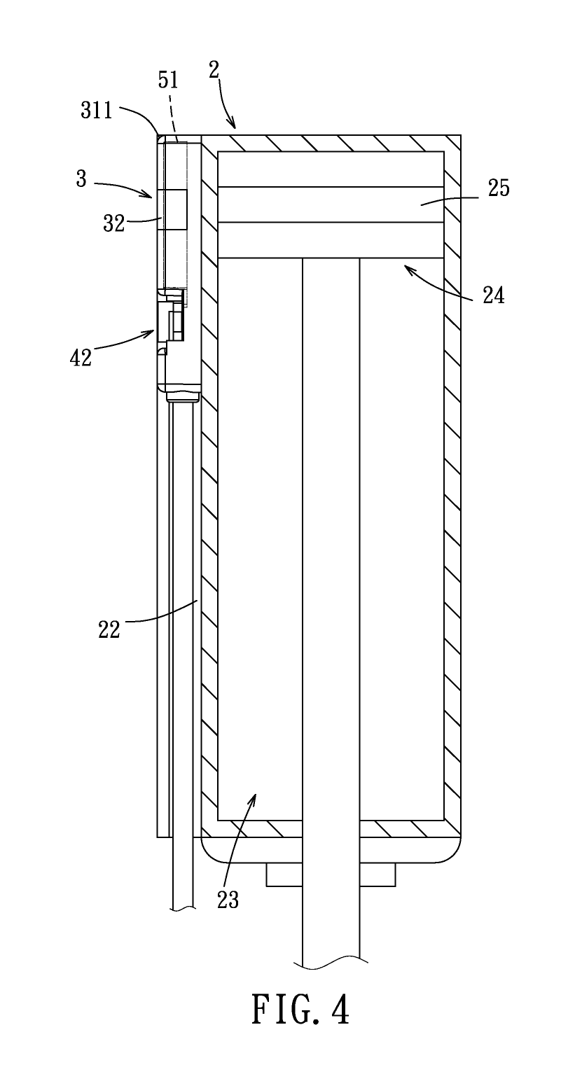

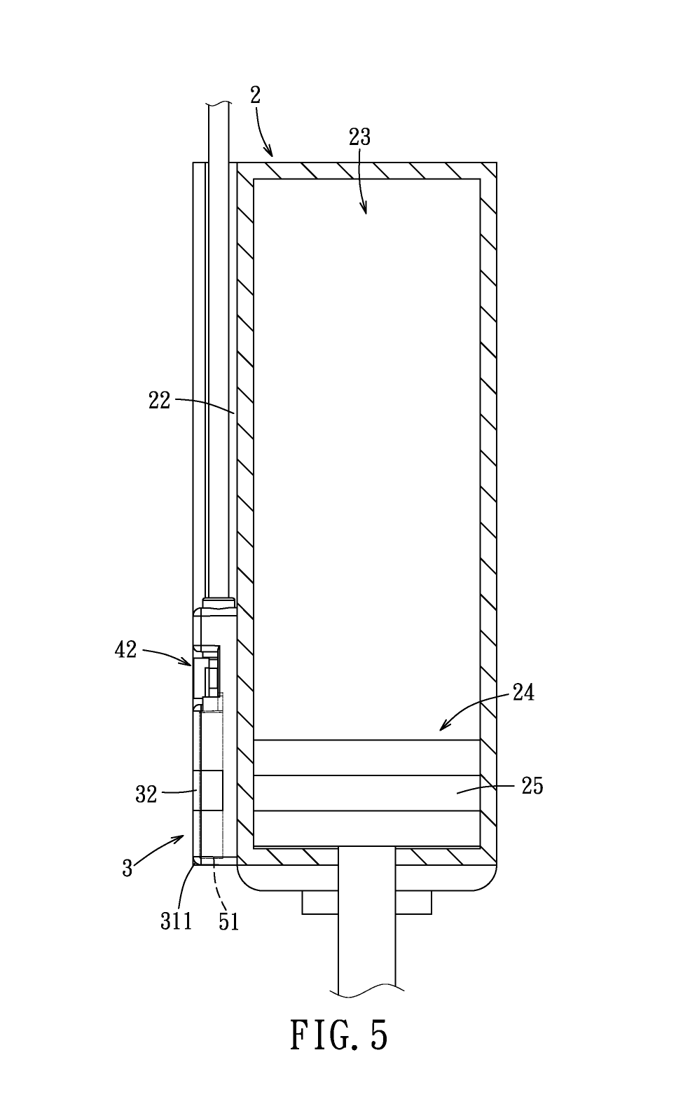

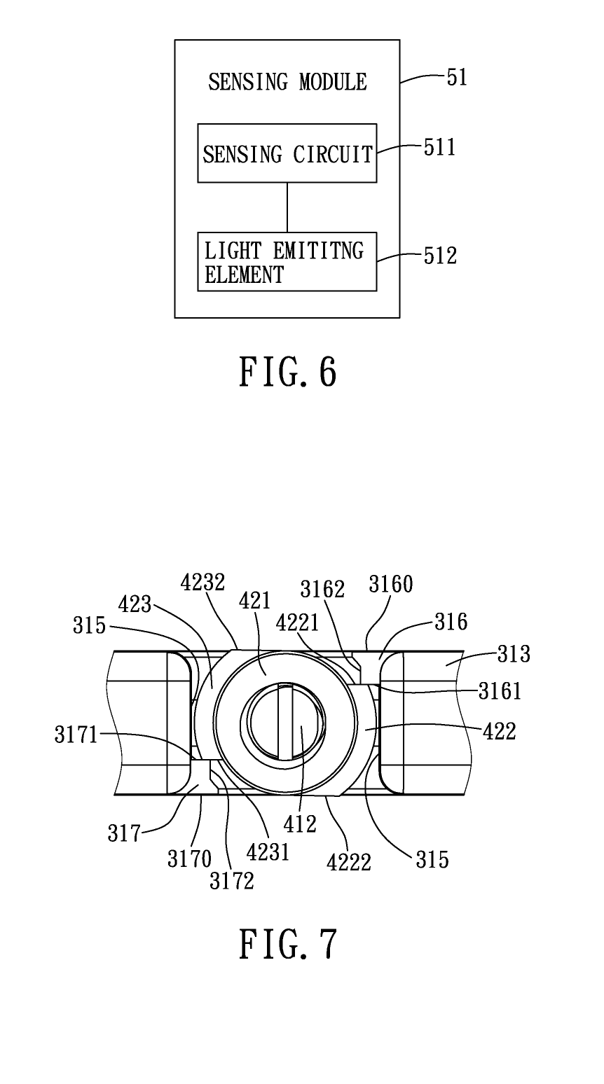

Referring to FIGS. 2 to 11, a magnetic sensor 100 according to the preferred embodiment of this invention is adapted to be disposed on an outer surface 21 of a pressure cylinder 2. The outer surface 21 is formed with a plurality of channels 22 that extend along a length of the pressure cylinder 2. The magnetic sensor 100 is adapted to be placed in one of the channels 22. The pressure cylinder 2 may be a pneumatic or a hydraulic cylinder. Each channel 22 is defined by an inner wall 211, two sidewalls 212 extending outwardly and respectively from two opposite sides of the inner wall 211, and two blocking portions 213 respectively extending from outer ends of the sidewalls 212 that are distal from the inner wall 211 toward each other. The pressure cylinder 2 includes an inner chamber 23 that extends along the length thereof, a piston 24 that moves reciprocally and linearly within the inner chamber 23, and a magnetic portion 25 provided on an outer surface of the piston 24. The piston 24 is movable between a top dead point position, as shown in FIG. 4, and a bottom dead point position, as shown in FIG. 5.

The magnetic sensor 100 comprises a hollow casing 3, a positioning unit 4, and a circuit unit 5.

The hollow casing 3 has a long and narrow shape, and includes a casing body 31 having a first end 311 and a second end 312 opposite to each other along a length of the casing body 31, a lamp cover 32 connected to the casing body 31 in proximity to the first end 311, a receiving notch 33 formed in an outer surface 313 of the casing body 31 in proximity to the second end 312, and a through hole 318 formed below and communicating with the receiving notch 33. The receiving notch 33 has a rectangular shape, and is defined by a notch inner wall 314 and two opposite notch sidewalls 315 connected respectively to two opposite ends of the notch inner wall 314 and spaced apart from each other along a length of the receiving notch 33.

The casing body 31 further has a first blocking member 316 projecting from one of the notch sidewalls 315 toward the receiving notch 33, and a second blocking member 317 projecting from the other one of the notch sidewalls 315 toward the receiving notch 33 and staggered with the first blocking member 316. The first blocking member 316, as shown in FIG. 7, has an outer surface 3160 flush with the outer surface 313 of the casing body 31, a first blocking surface 3161 parallel to and spaced apart from the outer surface 3160, and a second blocking surface 3162 connected between the outer surface 3160 and the first blocking surface 3161. The second blocking member 317, as shown in FIG. 7, has an outer surface 3170 flush with the outer surface 313 of the casing body 31, a first blocking surface 3171 parallel to and spaced apart from the outer surface 3170, and a second blocking surface 3172 connected between the outer surface 3170 and the first blocking surface 3171.

The positioning unit 4 includes an adjustment member 41 and a bushing 42. The bushing 42 is disposed in the receiving notch 33, and has a tubular portion 421, and a protrusion protruding outwardly and radially from an outer peripheral surface of the tubular portion 421. The protrusion includes a first protruding portion 422 and a second protruding portion 423 protruding outwardly and oppositely from the outer peripheral surface of the tubular portion 421. Each of the first and second protruding portions 422, 423 has a sector shape, and has a first abutment surface 4221, 4231 and a second abutment surface 4222, 4232 opposite to each other along an arc length thereof.

The adjustment member 41 extends through the tubular portion 421, and has a rotary portion 411 retained rotatably in the through hole 318, and a head portion 412 fixed to the tubular portion 421. In this embodiment, the tubular portion 421 of the bushing 42 is formed with an internal thread aligned with the through hole 318, and the head portion 412 of the adjustment member 41 has an external thread engaged threadedly to the internal thread of the tubular portion 421. A top surface of the head portion 412 is slotted for engagement with a screwdriver or other suitable tools.

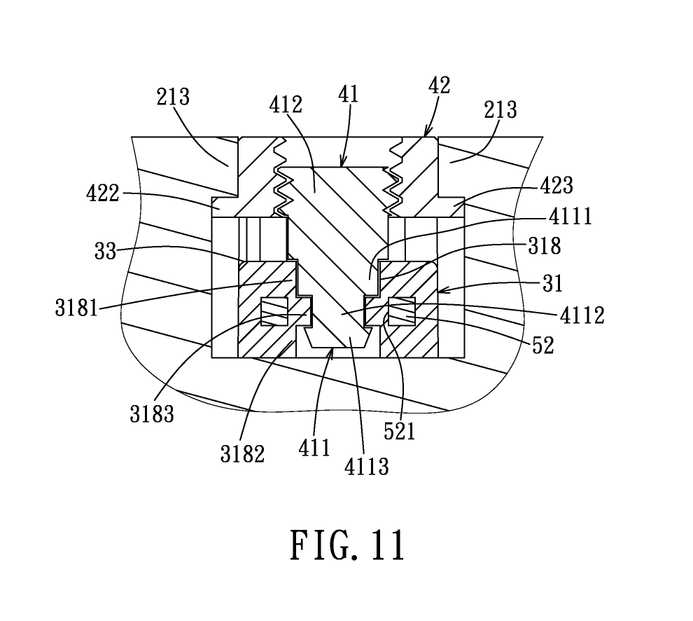

As shown in FIG. 11, the through hole 318 in the casing body 31 includes a first large diameter hole section 3181 proximate to the bushing 42, a second large diameter hole section 3182 distal from the bushing 42, and an intermediate hole section 3183 that is between the first and second large diameter hole sections 3181, 3182 and that has a diameter smaller than that of the first and second large diameter hole sections 3181, 3182. Further, the rotary portion 411 has a stepped configuration, and includes a large diameter part 4111 received in the first large diameter hole section 3181, a necked part 4112 received in the intermediate hole section 3183, and a butt end part 4113 received in the second large diameter hole section 3182 and having a diameter larger than that of the intermediate hole section 3183. Thus, the rotary portion 411 is retained rotatably in the through hole 318, and the adjustment member 41 is limited to rotate within the through hole 318. The head portion 412 has a diameter larger than a largest diameter of the rotary portion 411.

The circuit unit 5 includes a sensing module 51 disposed in the casing body 31 in proximity to the first end 311, a circuit board 52 electrically connected to the sensing module 51, and a guide wire 53 electrically connected to the circuit board 52 and proximate to the second end 312 of the casing body 31. The sensing module 51 has a sensing circuit 511 and a light emitting element 512. The sensing circuit 511 senses a magnetic field generated by the magnetic portion 25, and generates and outputs a control signal in response to the sensed magnetic field. The light emitting element is electrically connected to the sensing circuit 511, and corresponds in position to the lamp cover 32. When the sensing circuit 511 senses the approach of the magnetic field of the magnetic portion 25, it controls illumination of the light emitting element 512. The sensing circuit 511 has a reed switch or a semiconductor magnetic component to achieve the function of magnetic sensing. Since the sensing circuit 511 is known in the art, a detailed description thereof is dispensed herewith.

The light emitting element 512 is a light emitting diode. With reference to FIGS. 2 and 11, the circuit board 52 is disposed below the receiving notch 33, and has a through hole 521 corresponding in position to the through hole 318. Because the through hole 521 has a diameter greater than that of the intermediate hole section 3183 of the through hole 318, when the casing body 31 is molded over the circuit board 52, the intermediate hole section 3183 of the through hole 318 is within the through hole 521 of the circuit board 52. The guide wire 53 electrically connects a sensing signal outputted by the sensing module 51 to a power source and a control circuit (not shown).

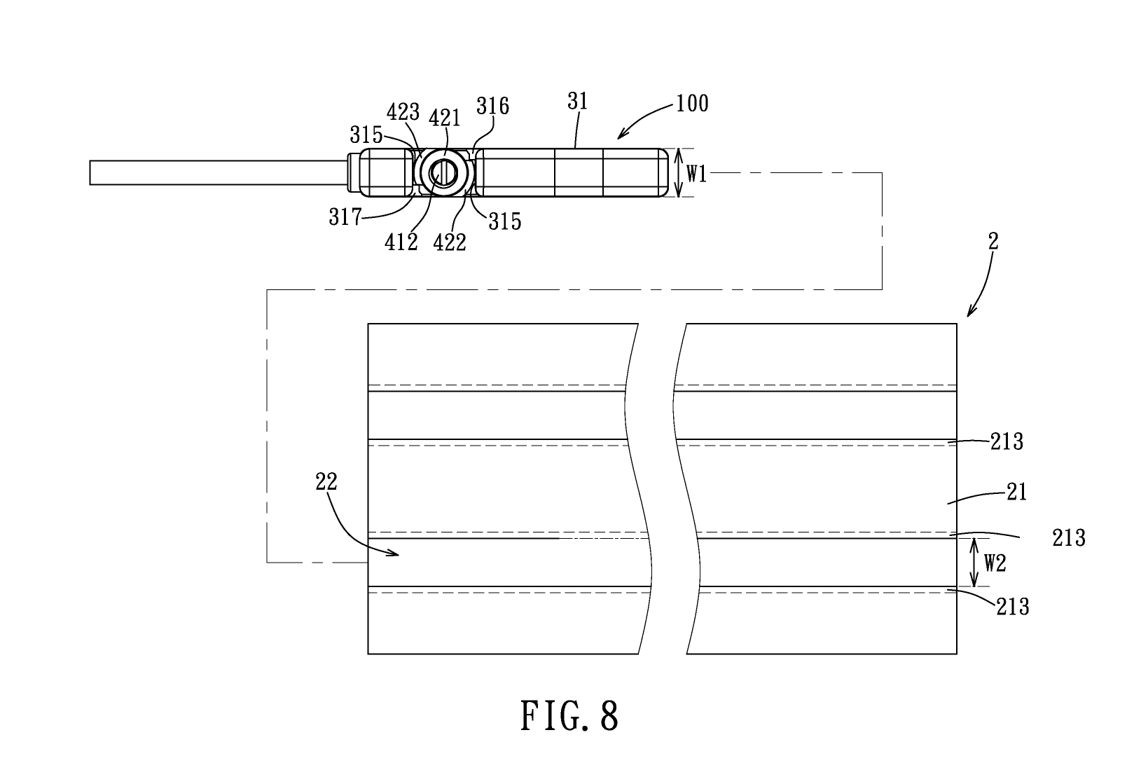

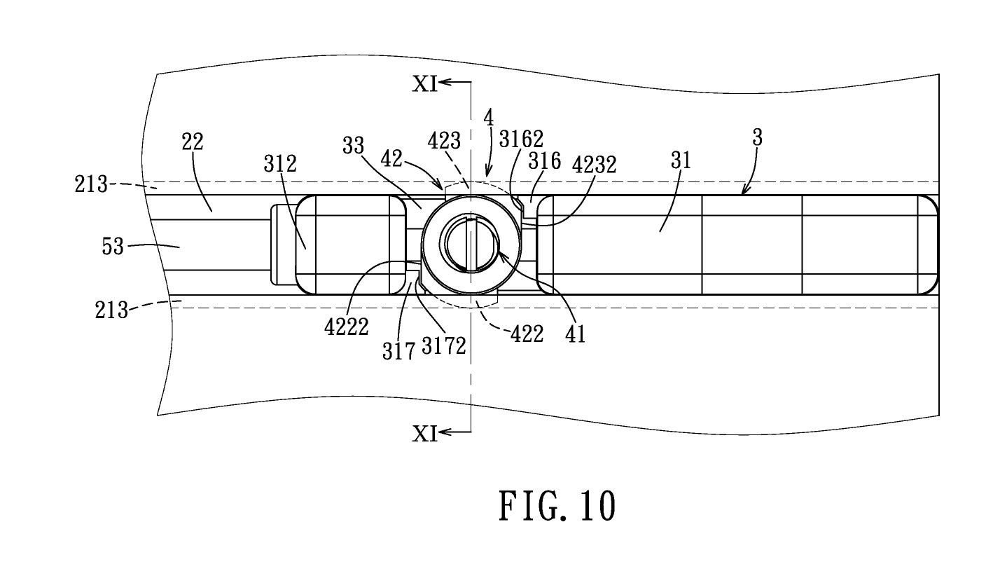

With reference to FIG. 8, to permit insertion of the magnetic sensor 100 into a selected one of the channels 22 in the outer surface 21 of the pressure cylinder 2 through a space defined by the two blocking portions 213 and in a direction perpendicular to the length of the pressure cylinder 2, the casing body 31 is designed to have a width (W1) slightly smaller than a distance (W2) between the two blocking portions 213. The bushing 42 is rotatable relative to the casing body 31 between a protruded position and a retracted position. In the protruded position, the first and second protruding portions 422, 423 are protruded out of the receiving notch 33, as shown in FIG. 10, and the bushing interlocks with the blocking portions 213. In the retracted position, the first and second protruding portions 422, 423 are rectracted into the receiving notch 33, as shown in FIGS. 7 to 9, and the bushing 42 uninterlocks with the blocking portions 213.

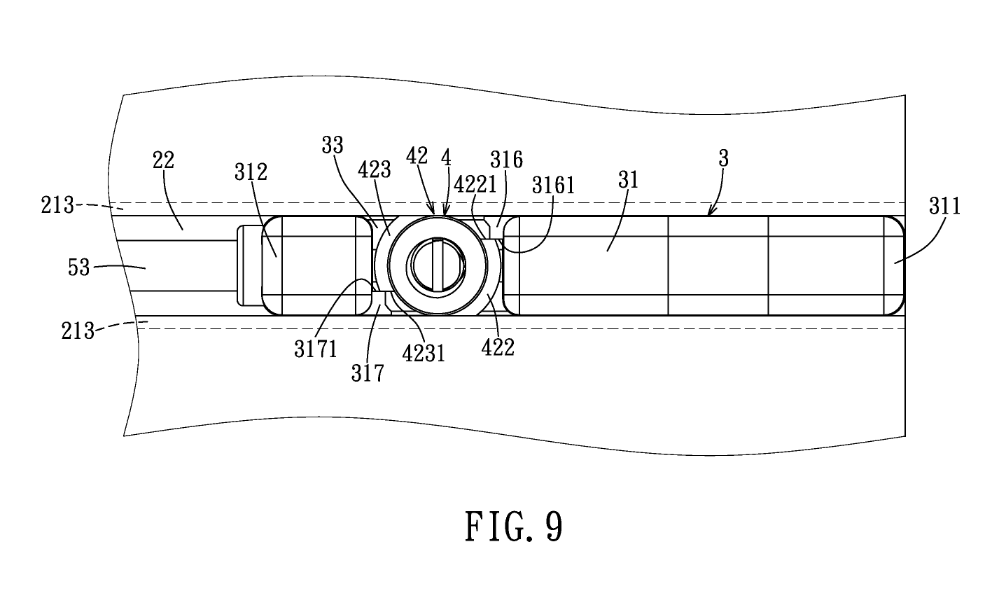

With reference to FIG. 9, when the bushing 42 is in the retracted position, the first abutment surface 4221 of the first protruding portion 422 abuts against the first blocking surface 3161 of the first blocking portion 316, and the first abutment surface 4231 of the second protruding portion 423 abuts against the first blocking face 3171 of the second blocking portion 317. As such, the magnetic sensor 100 can be inserted into the selected channel 22 to be positioned at a particular position. For example, the first end 311 of the casing body 31 can be disposed in proximity to the piston 24 at the top dead point position shown in FIG. 4 or the bottom dead point position shown in FIG. 5.

With reference to FIGS. 10 and 11, to rotate the bushing from the retracted position to the protruded position, an external force is applied to the adjustment member 41 by using a screwdriver or other suitable tools, so that the first and second protruding portions 422, 423 protrude out of the receiving notch 33 and respectively abut against the blocking portions 213, thereby interlocking the bushing 42 with the blocking portions 213. At this time, the magnetic sensor 100 is fixed in the selected channel 22 at a particular position. Depending on the depth of the channel 22, the second abutment surface 4222 of the first protruding portion 422 may not necessarily abut against the second blocking surface 3172 of the second blocking member 317, and the second abutment surface 4232 of the second protruding portion 423 may not necessarily abut against the second blocking surface 3162 of the first blocking member 316. With reference to FIG. 7, during rotation of the bushing 42, since the first protruding portion 422 can only rotate between the first blocking surface 3161 of the first blocking member 316 and the second blocking surface 3172 of the second blocking member 317, and the second protruding portion 423 can only rotate between the second blocking surface 3162 of the first blocking member 316 and the first blocking surface 3171 of the second blocking member 317, the first and second blocking members 316, 317 produce an effect of limiting the first and second protruding portions 422, 423 within a certain range of rotation.

Because of the retracted position of the bushing 42, as shown in FIG. 9, the magnetic sensor 100 not only can be inserted into the selected channel 22 through one end thereof, but also can be inserted into the selected channel 22 through a space defined by the two blocking portions 213. Hence, assembly of the present invention is easy and simple. On the other hand, when the bushing 42 is in the protruded position, as shown in FIGS. 10 and 11, the positioning unit 4 and the guide wire 53 are proximate to the second end 312, so that positioning of the guide wire 53 is stable and may not affect transmission of signal.

With reference to FIGS. 4 to 6, because the sensing module 51 is proximate to the first end 311, when the first end 311 of the casing body 31 is proximate to the piston 24 which is either located at the top dead point position shown in FIG. 4 or the bottom dead point position shown in FIG. 5, the sensing circuit 511 of the sensing module 51 is close to the magnetic portion 25 that is provided on the outer surface of the piston 24, and can thus easily sense the magnetic field generated by the magnetic portion 25. As a result, a sensing signal generated by the sensing circuit 511 in response to the sensed magnetic field is accurate and has a small error. Further, when the sensing circuit 511 senses the approach of the magnetic field, it will control illumination of the light emitting element 512, so that light from the light emitting element 512 passes through the lamp cover 32, thereby permitting the detection of the magnetic sensor 100 more intuitive.

In summary, the magnetic sensor 100 of the present invention can be inserted into a selected one of the channels 22 through a space defined by the two blocking portions 213 and be positioned at a particular position when the bushing 42 is in the retracted position, so that assembly of the magnetic sensor 100 is easy and simple. Further, when the bushing 42 is in the protruded position, because the sensing module 51 is proximate to the first end 311 of the casing body 31 and the first end 311 is proximate to the top dead point position or the bottom dead point position of the piston 24, the sensing circuit 511 of the sensing module 51 is close to the magnetic portion 25 and can accurately sense the magnetic field of the magnetic portion 25, so that the corresponding sensing signal generated therefrom can be accurate and has a small error. Moreover, the positioning unit 4 and the guide wire 53 are proximate to the second end 312 of the casing body 31, so that positioning of the guide wire 53 is stable and may not affect transmission of signal. Therefore, the object of the present invention can be realized.

While the present invention has been described in connection with what is considered the most practical and preferred embodiment, it is understood that this invention is not limited to the disclosed embodiment but is intended to cover various arrangements included within the spirit and scope of the broadest interpretations and equivalent arrangements.

What is claimed is:

1. A magnetic sensor for placement in a channel of a pressure cylinder, the channel being formed in an outer surface of the pressure cylinder and extending along a length of the pressure cylinder, the channel being defined by an inner wall, two sidewalls extending outwardly and respectively from two opposite sides of the inner wall, and two blocking portions respectively extending from outer ends of the sidewalls that are distal from the inner wall toward each other, the pressure cylinder including an inner chamber that extends along the length thereof, a piston that moves reciprocally and linearly within the inner chamber, and a magnetic portion provided on an outer surface of the piston, said magnetic sensor comprising:
a hollow casing including a casing body that has a width slightly smaller than a distance between the two blocking portions, said casing body having a first end and a second end opposite to each other along a length of said casing body, a receiving notch formed in an outer surface of said casing body in proximity to said second end, and a through hole formed below and communicating with said receiving notch;
a positioning unit including an adjustment member and a bushing, said bushing being disposed in said receiving notch and having a tubular portion, and a protrusion protruding outwardly and radially from an outer peripheral surface of said tubular portion, said adjustment member extending through said tubular portion and having a rotary portion retained rotatably in said through hole, and a head portion fixed to said tubular portion, said bushing being rotatable relative to said casing body between a protruded position, where said protrusion is protruded out of said receiving notch so that said bushing interlocks with the blocking portions of the pressure cylinder, and a retracted position, where said protrusion is retracted into said receiving notch so that said bushing uninterlocks with the blocking portions; and
a circuit unit including a sensing module disposed in said casing body in proximity to said first end, said sensing module having a sensing circuit that is adapted to sense a magnetic field generated by the magnetic portion and that generates and outputs a control signal in response to the sensed magnetic field.

2. The magnetic sensor of claim 1, wherein said tubular portion of said bushing is formed with an internal thread aligned with said through hole, and said head portion of said adjustment member has an external thread engaged threadedly with said internal thread of said tubular portion.

3. The magnetic sensor of claim 1, wherein said receiving notch is defined by a notch inner wall, and two notch sidewalls connected respectively to two opposite ends of said notch inner wall and spaced apart from each other along a length of said receiving notch.

4. The magnetic sensor of claim 3, wherein said casing body further has a first blocking member projecting from one of said notch sidewalls toward said receiving notch, and a second blocking member projecting from the other one of said notch sidewalls toward said receiving notch and staggered with said first blocking member.

5. The magnetic sensor of claim 4, wherein said protrusion includes a first protruding portion and a second protruding portion protruding outwardly and oppositely from said outer peripheral surface of said tubular portion, when said bushing is in said protruded position, said first and second protruding portions are protruded out of said receiving notch for abutting respectively against the blocking portions of the pressure cylinder.

6. The magnetic sensor of claim 5, wherein said first blocking member has an outer surface flush with said outer surface of said casing body, and a first blocking surface parallel to and spaced apart from said outer surface of said first blocking member, said second blocking member having an outer surface flush with said outer surface of said casing body, and a first blocking surface parallel to and spaced apart from said outer surface of said second blocking member, said first protruding portion having a first abutment end surface that abuts against said first blocking surface of said first blocking member when said bushing is in said retracted position, said second protruding portion having a first abutment end surface that abuts against said first blocking surface of said second blocking member when said bushing is in said retracted position.

7. The magnetic sensor of claim 1, wherein said hollow casing further includes a lamp cover connected to said casing body in proximity to said first end, said sensing module further having a light emitting element that is connected electrically to said sensing circuit and that corresponds in position to said lamp cover, when said sensing circuit senses the approach of the magnetic field of the magnetic portion, said sensing circuit controls illumination of said light emitting element.

8. The magnetic sensor of claim 1, wherein said circuit unit further includes a circuit board connected electrically to said sensing module, and a guide wire connected electrically to said circuit board and proximate to said second end of said casing body.

9. The magnetic sensor of claim 1, wherein said through hole in said casing body includes a first large diameter hole section proximate to said bushing, a second large diameter hole section distal from said bushing, and an intermediate hole section that is between said first and second large diameter hole sections and that has a diameter smaller than that of said first and second large diameter hole sections, said rotary portion having a stepped configuration and including a large diameter part received in said first large diameter hole section, a necked part received in said intermediate hole section, and a butt end part received in said second large diameter hole section and having a diameter larger than that of said intermediate hole section.
